(19) United States
(12) Patent Application Publication
(10) Pub. No.: US 2009/0243919 A1
(43) Pub. Date: Oct. 1, 2009

(54) RECEIVER AND SIGNAL PROCESSING SYSTEM

(75) Inventor: Masaru SATO, Kawasaki (JP)

Correspondence Address: ARENT FOX LLP, 1050 CONNECTICUT AVENUE, N.W., SUITE 400, WASHINGTON, DC, 20036, US

(73) Assignee: FUJITSU LIMITED, Kawasaki (JP)

(21) Appl. No.: 12/412,007

(22) Filed: Mar. 26, 2009

(30) Foreign Application Priority Data
Mar. 27, 2008 (JP) 2008-084258

(51) Int. Cl. G01S 3/02

(52) U.S. Cl. 342/351

(57) ABSTRACT

A receiver includes a detector configured to detect a signal and output an output signal, a state section configured to control the signal inputting into the detector according to a level of a control signal, an edge section configured to discard the output signal of the detector while detecting an edge of the control signal, and leave the output signal of the detector while not detecting the edge of the control signal, a high/low level section configured to multiply the output signal which is left by the edge section by a first coefficient while the level of the control signal is high, and multiply the output signal which is left by the edge section by a second coefficient while the level of the control signal is low, and an adding section configured to output a first signal multiplied by the first coefficient and second signal multiplied by the second coefficient.

### CROSS REFERENCE TO RELATED APPLICATION

This application is based upon and claims the benefit of priority from prior Japanese Patent Application No. 2008-084258, filed on Mar. 27, 2008, the entire contents of which are incorporated herein by reference.

### FIELD

The present invention relates to a receiver and a signal processing system.

### BACKGROUND

A millimeter wave receiver is a circuit for detecting a minute millimeter wave signal emitted from an object or a celestial body. A Dicke-type receiver is configured to suppress variation in the detection level due to time and temperature variations of the gain of the receiver. The Dicke-type receiver is described, for example, in the M. E. Tiuri, “Radio Astronomy Receivers”, IEEE Trans. On Antenna and Propagation, vol. AP, and pp. 930-938, Dec. 1, 1964, and M. K. Joung, “Study on millimeter wave band passive imaging”, Doctor thesis at Tohoku University, Mar. 31, 2004.

FIG. 11 is a figure illustrating a Dicke-type receiver. FIGS. 12A to 12D are waveform charts of signals SR, SA, SB and SC in the case where there is an input signal. FIGS. 13A to 13D are waveform charts of the signals SR, SA, SB and SC in the case where there is no input signal.

A switch driver 1104 outputs the control signal SR for controlling a switch 1102. The control signal SR is, for example, a signal of 100 Hz. A millimeter wave radio signal from an antenna 1101 is applied through the switch 1102 to an input terminal of a low noise amplifier 1111 at the time when the control signal SR is at a high level, for example, +5 V. The switch 1102 connects the input terminal of the low noise amplifier 1111 to a reference potential node via a resistor 1103 at the time when the control signal SR is at a low level, for example, −5 V. The low noise amplifier 1111 amplifies the input signal and outputs the amplified signal to a millimeter wave detector 1112. The millimeter wave detector 1112 detects a high frequency millimeter wave signal, and outputs the DC signal (low frequency signal) SA. When the control signal SR is at the high level, the signal SA is set, for example, to 1 V (FIG. 12B) or −0.9 V (FIG. 13B). When the control signal SR is at the low level, the signal SA is set, for example, to −1 V. In the period in which the control signal SR is at the high level, the signal SA is set to +1 V at the time when the antenna 1101 receives a millimeter wave, and the signal SA is set to −0.9 V at the time when the antenna 1101 receives no millimeter wave. A phase adjuster 1105 adjusts the phase of the control signal SR outputted by the switch driver 1104, and controls a switch 1113 in correspondence with the control of the switch 1102. The switch 1113 connects the output terminal of the detector 1112 to an input terminal of a multiplier 1114 or an input terminal of a multiplier 1115 according to the control of the phase adjuster 1105. When the switch 1102 is connected to the antenna 1101, the switch 1113 is connected to the multiplier 1114. When the switch 1102 is connected to the reference potential node via the resistor 1103, the switch 1113 is connected to the multiplier 1115. The multiplier 1114 multiplies the signal SA by +1, and outputs the multiplied signal. The multiplier 1115 multiplies the signal SA by −1, and outputs the multiplied signal.

An adder 1116 adds the outputs of the multipliers 1114 and 1115, and outputs the signal SB. Specifically, when the switch 1113 is connected to the multiplier 1114, the adder 1116 selects the output signal of the multiplier 1114 to output the selected signal as the signal SB. When the switch 1113 is connected to the multiplier 1115, the adder 1116 selects the output signal of the multiplier 1115 to output the selected signal as the signal SB. A low pass filter (LPF) 1117 passes only a low frequency band signal of the signal SB, and outputs the signal SC. When the cutoff frequency of the LPF 1117 is further lowered, the signal SB is further averaged, so that the signal SC becomes close to 0.1 V. A data measuring section 1118 measures the voltage value of the signal SC.

In a half period of one cycle, the switch 1102 is connected to the antenna 1101, and the signal SA at the period includes a millimeter wave signal component and a noise component of the amplifier 1111. In the residual half period of the one cycle, the switch 1102 is connected to the resistor 1103, and the signal SA at the period includes only the noise component of the amplifier 1111. By switching the switch 1113 in synchronization with the switch 1102, it is possible to remove the noise component and the time and temperature variations in the gain of the amplifier 1111.

FIGS. 12A to 12D illustrate an example in which the control signal SR is completely synchronized with the signal SA. However, in practice, the control signal SR may be slightly out of synchronism with the signal SA.

FIGS. 14A to 14D are figures which correspond to FIGS. 12A to 12D and which illustrate voltage waveforms of the signals SR, SA, SB and SC at the time when the phase of the signal SA is shifted from the phase of the control signal SR by 5%. In the signal SB illustrated in FIG. 14C, a sharp spike voltage is generated at a portion in which the control signal SR is out of synchronism with the signal SA. Usually, the signal SC is generated by removing the high frequency components of the signal SB with the low pass filter 1117. The signal SC illustrated in FIG. 14D is a waveform in the case where the cutoff frequency of the low pass filter 1117 is set at about 500 Hz. As illustrated in the figure, the spike waveform is not sharp, but the spike waveform still remains in the signal SC. The average voltage of the signal SC, which is originally to be 1 V (FIG. 12D), is 0.806 V, and hence is influenced by the error caused by the spike. When the cutoff frequency of the low pass filter 1117 is set to 100 Hz or less, the spike in the signal SC is almost eliminated. However, the integration time is increased thereby causing the response speed to be lowered. Therefore, it is necessary to completely synchronize the signals with each other by the phase adjuster 1105.

FIGS. 15A to 15D are figures which correspond to FIGS. 12A to 12D, and which illustrate voltage waveforms of the signals SR, SA, SB and SC in the case where the rise time and fall time of the control signal SR are different from the rise time and fall time of the signal SA. Even when the switch 1102 is switched, there is a difference in the response time. This results in the differences in the rise time and fall time between the control signal SR and the signal SA. In this phenomenon, it is difficult to correct the rise time. The spikes appear in the signals SB and SC. Also, the average voltage of the signal SC is 0.86 V, and hence an error is generated.

As described above, in the above referenced receiver, it is necessary to make the phases of the signal SA and the control signal SR completely coincide with each other. Further, since the rise time and fall time of the signal SA are different from the rise time and fall time of the control signal SR, the spike voltages are generated, and thereby the error is caused in the measured voltage. When the cutoff frequency of the LPF 1117 is lowered in order to remove the spike voltage, there arises the problem that the response speed is lowered.

### SUMMARY

Accordingly, it is an object in one aspect of the invention to provide a receiver includes a detector configured to detect a signal and output an output signal, a state section configured to control the signal inputting into the detector according to a level of a control signal, an edge section configured to discard the output signal of the detector while detecting an edge of the control signal, and leave the output signal of the detector while not detecting the edge of the control signal, a high/low level section configured to multiply the output signal which is left by the edge section by a first coefficient while the level of the control signal is high, and multiply the output signal which is left by the edge section by a second coefficient while the level of the control signal is low, and an adding section configured to output a first signal multiplied by the first coefficient and second signal multiplied by the second coefficient.

The object and advantages of the invention will be realized and attained by means of the elements and combinations particularly pointed out in the claims.

It is to be understood that both the foregoing general description and the following detailed description are exemplary and explanatory and are not restrictive of the invention, as claimed.

### BRIEF DESCRIPTION OF THE DRAWINGS

FIG. 1 is a figure illustrating a Dicke-type receiver according to a first embodiment of the present invention;

FIGS. 2A to 2D are waveform charts of signals in the case where there is an input signal;

FIG. 3 is a figure illustrating a Dicke-type receiver according to a second embodiment of the invention;

FIG. 4 is a figure illustrating a Dicke-type receiver according to a third embodiment of the present invention;

FIG. 5A is a figure illustrating a Dicke-type receiver according to a fourth embodiment of the present invention;

FIG. 5B is a waveform chart for explaining an operation of the apparatus illustrated in FIG. 5A;

FIGS. 6A to 6C are circuit diagrams illustrating examples of a millimeter wave receiver;

FIG. 7 is a circuit diagram illustrating an example of a detector;

FIG. 8 is a figure illustrating a receiver and a signal processing system according to a sixth embodiment of the present invention;

FIG. 9 is a figure illustrating a signal processing system according to a fifth embodiment of the present invention;

FIG. 10 is a block diagram illustrating an example of a hardware configuration of a computer according to embodiments;

FIG. 11 is a figure illustrating a Dicke-type receiver;

FIGS. 12A to 12D are waveform charts of signals in the case where there is an input signal;

FIGS. 13A to 13D are waveform charts of signals in the case where there is no input signal;

FIGS. 14A to 14D are figures illustrating voltage waveforms of signals in the case where the phase of the signal is shifted from the phase of the control signal by 5%; and

FIGS. 15A to 15D are figures illustrating voltage waveforms of signals in the case where the rise time and fall time of the control signal are different from the rise time and fall time of the signal.

### DESCRIPTION OF EMBODIMENTS

### First Embodiment

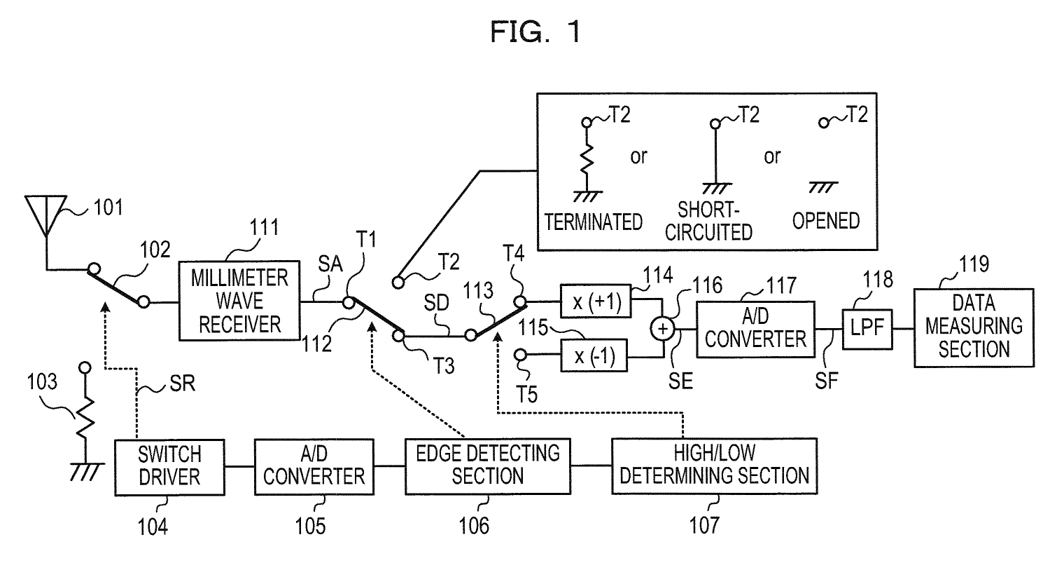

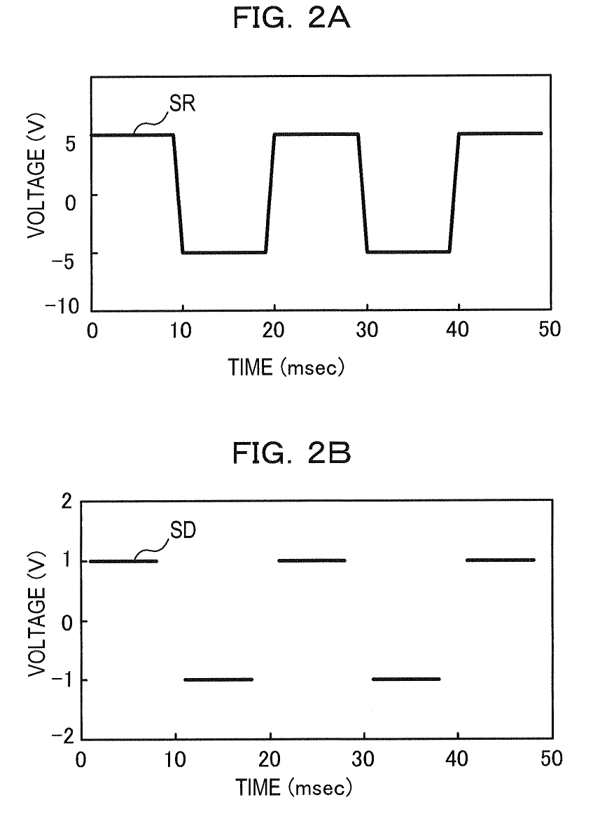

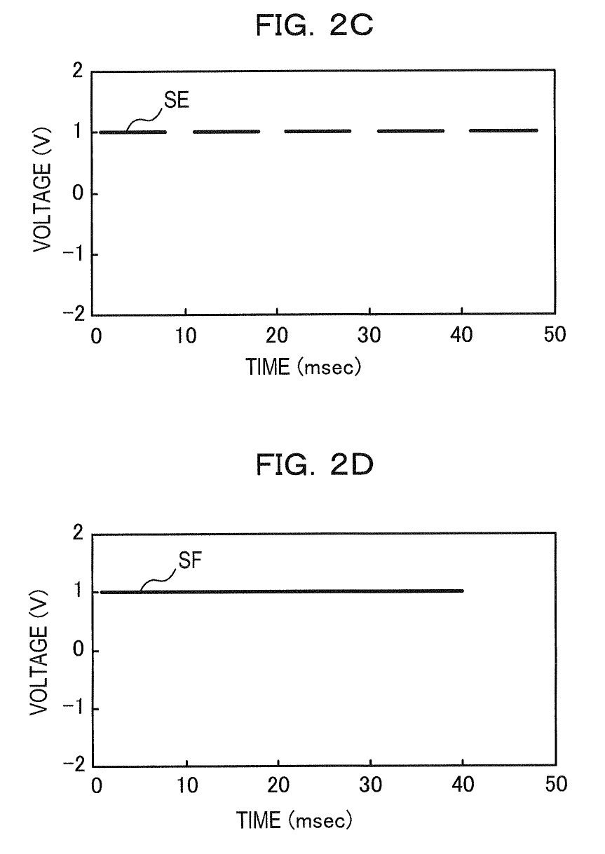

FIG. 1 is a figure illustrating a Dicke-type receiver according to a first embodiment of the present invention. FIGS. 2A to 2D are waveform charts of signals SR, SD, SE and SF in the case where there is an input signal.

A switch driver 104 outputs the control signal SR for controlling a switch 102. The control signal SR is, for example, a signal of 100 Hz. For example, a millimeter wave radio signal (radio wave) is received by an antenna 101. The switch 102 connects an input terminal of a millimeter wave receiver 111 to the antenna 101 at the time when the control signal SR is at a high level, for example, +5 V. The switch 102 connects the input terminal of the millimeter wave receiver 111 to a reference potential node via a resistor 103 at the time when the control signal SR is at a low level, for example, −5 V.

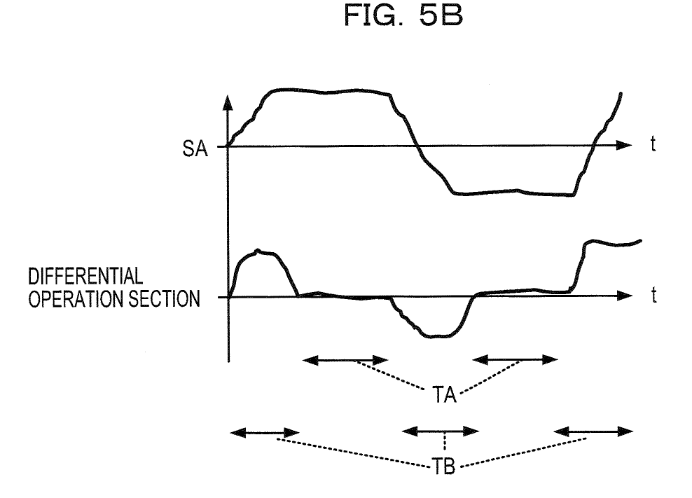

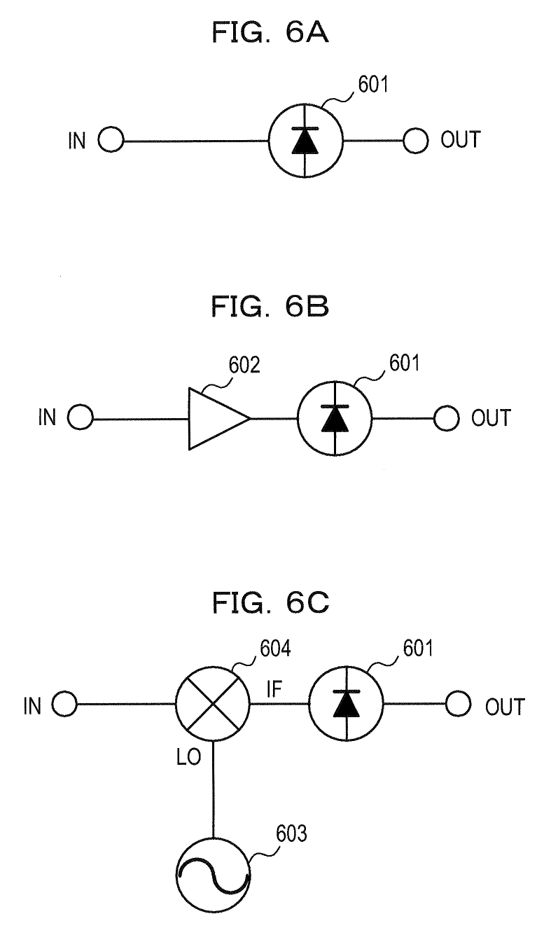

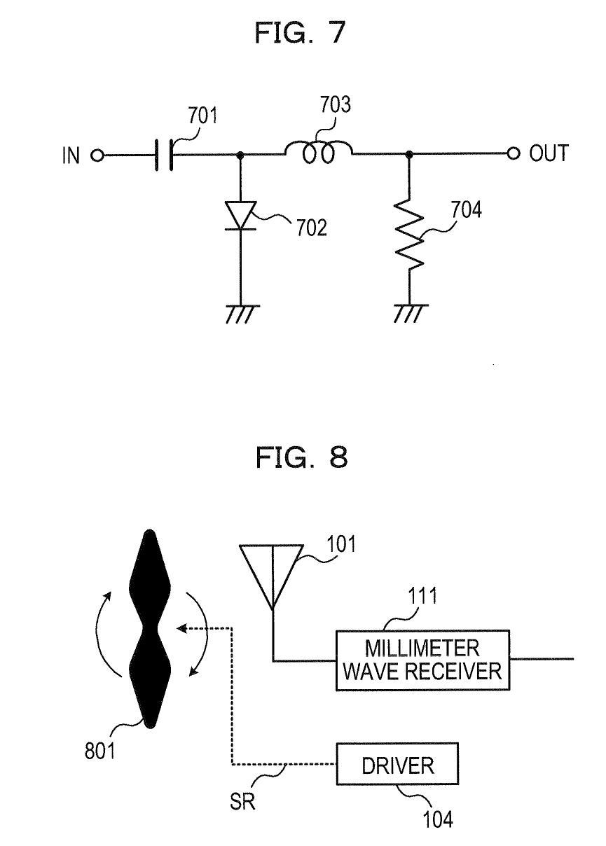

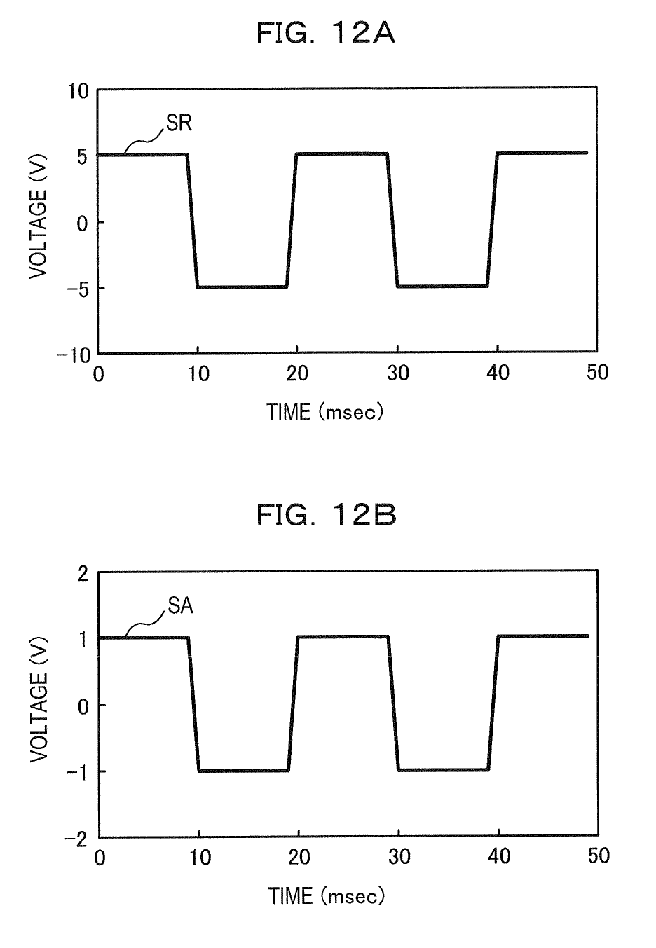

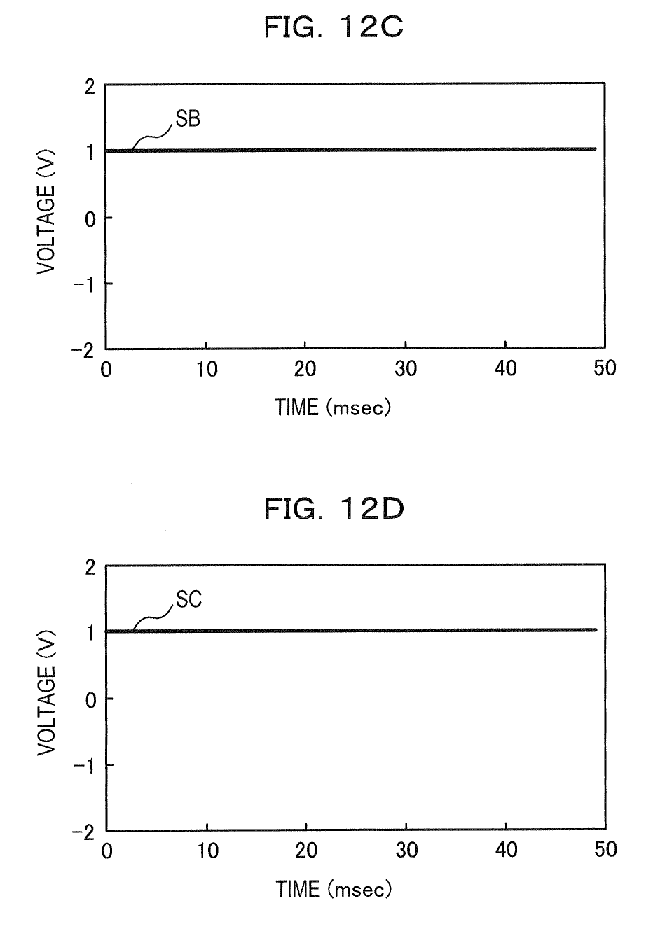

FIGS. 6A to 6C are circuit diagrams illustrating configuration examples of the millimeter wave receiver 111. The millimeter wave receiver 111 illustrated in FIG. 6A has a millimeter wave detector 601. The millimeter wave detector 601 detects a high frequency millimeter wave signal at an input terminal IN, and outputs a DC signal (low frequency signal) SA from an output terminal OUT. In one embodiment, the DC signal SA is the same as the signal SA illustrated in FIG. 12B. The circuit configuration of the millimeter wave detector 601 is described with reference to FIG. 7 below.

The millimeter wave receiver 111 illustrated in FIG. 6B includes the millimeter wave detector 601 and a low noise amplifier 602. The low noise amplifier 602 amplifies the input signal at the input terminal IN, and outputs the amplified signal to the millimeter wave detector 601. The millimeter wave detector 601 detects the high frequency millimeter wave signal outputted by the low noise amplifier 602, and outputs the DC signal SA from the output terminal OUT.

The millimeter wave receiver 111 illustrated in FIG. 6C includes the millimeter wave detector 601, an oscillation source 603, and a mixer 604. The oscillation source 603 outputs a local signal LO. The mixer 604 mixes the input signal at the input terminal IN with the local signal LO, and outputs an intermediate frequency signal IF. For example, when the input signal at the input terminal IN is a signal of 100 GHz and the local signal LO is a signal of 50 GHz, the intermediate frequency signal IF is set as a signal of 50 GHz (=100−50 GHz). A high frequency detector, for example, 100 GHz, may not be used as the millimeter wave detector 601, but a low frequency detector, for example, 50 GHz may be used as the millimeter wave detector 601. Since the millimeter wave detector 601 is operated at the low frequency, it is possible to improve the detection sensitivity and possible to reduce the cost.

FIG. 7 is a circuit diagram illustrating a configuration example of the millimeter wave detector 601. A capacitor 701 is connected between the input terminal IN and the anode of a diode 702. The cathode of the diode 702 is connected to the reference potential node. An inductor 703 is connected between the anode of the diode 702 and the output terminal OUT. A resistor 704 is connected between the output terminal OUT and the reference potential node. The millimeter wave detector 601 is capable of converting a high frequency AC signal at the input terminal IN into a DC signal (low frequency signal) by rectifying the high frequency AC signal by using the diode 702, and is capable of outputting the DC signal from the output terminal OUT.

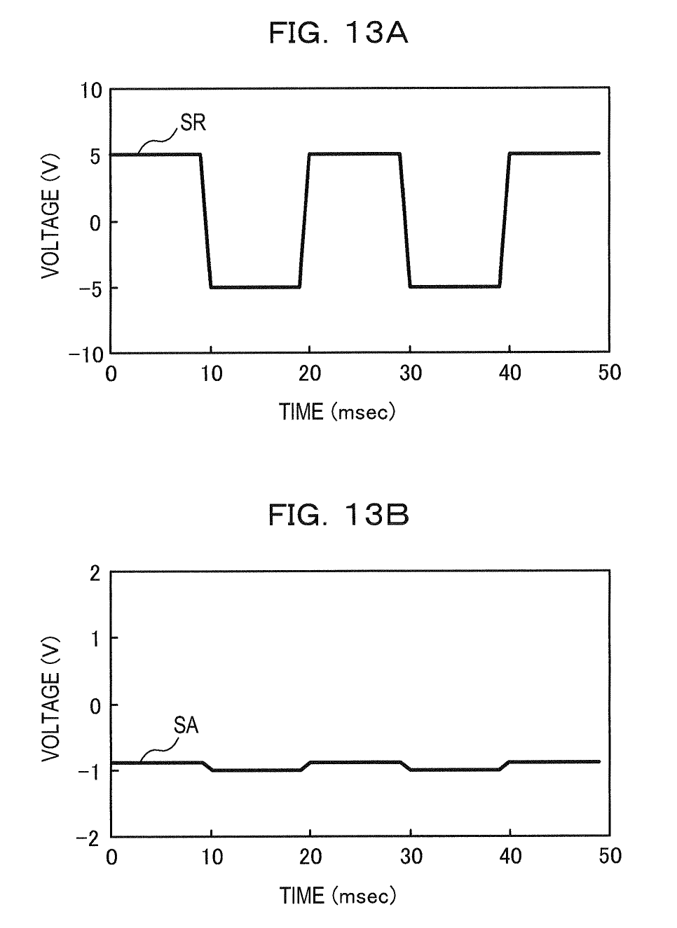

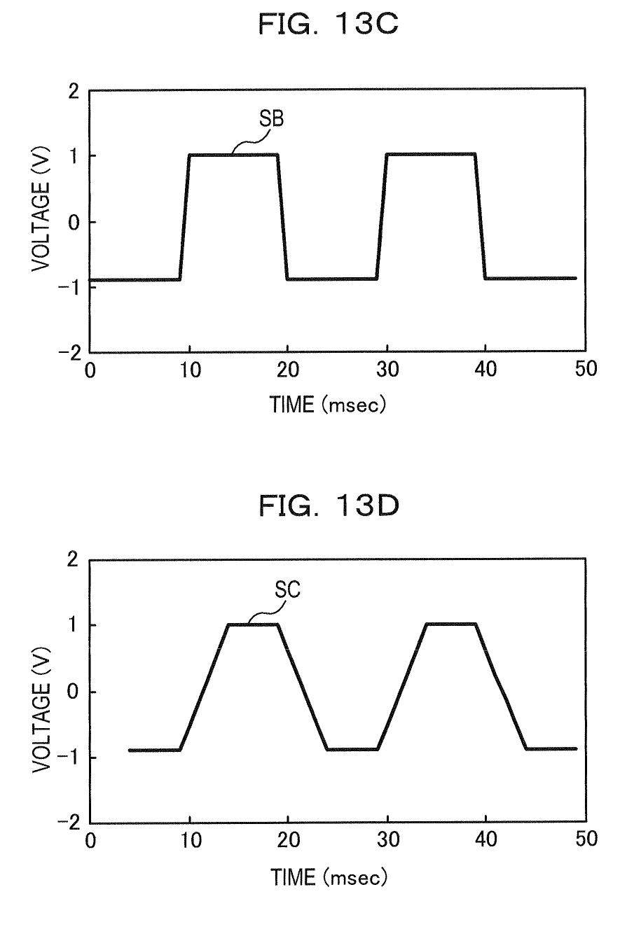

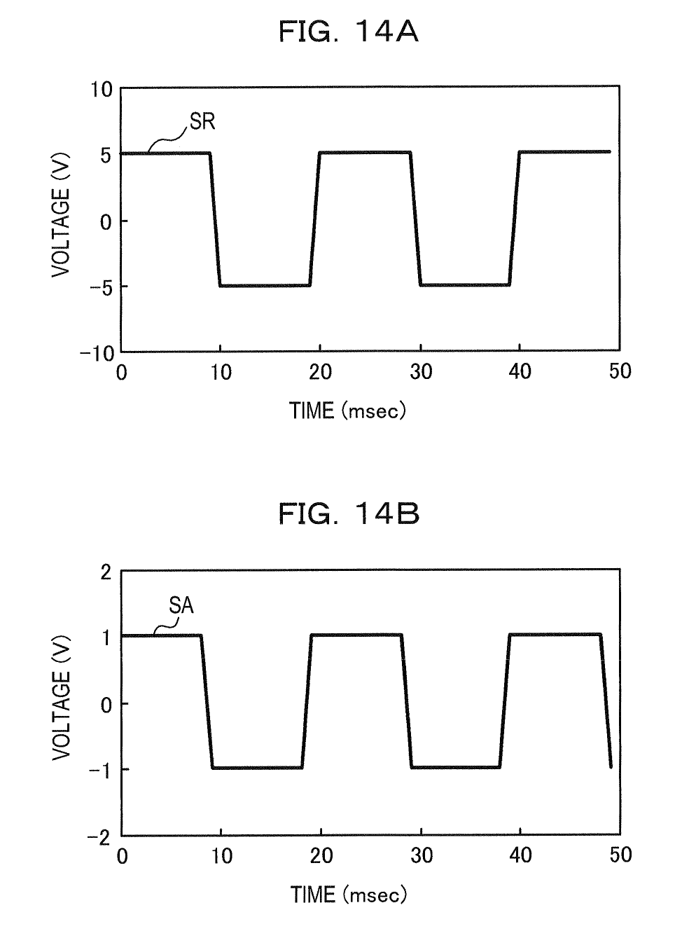

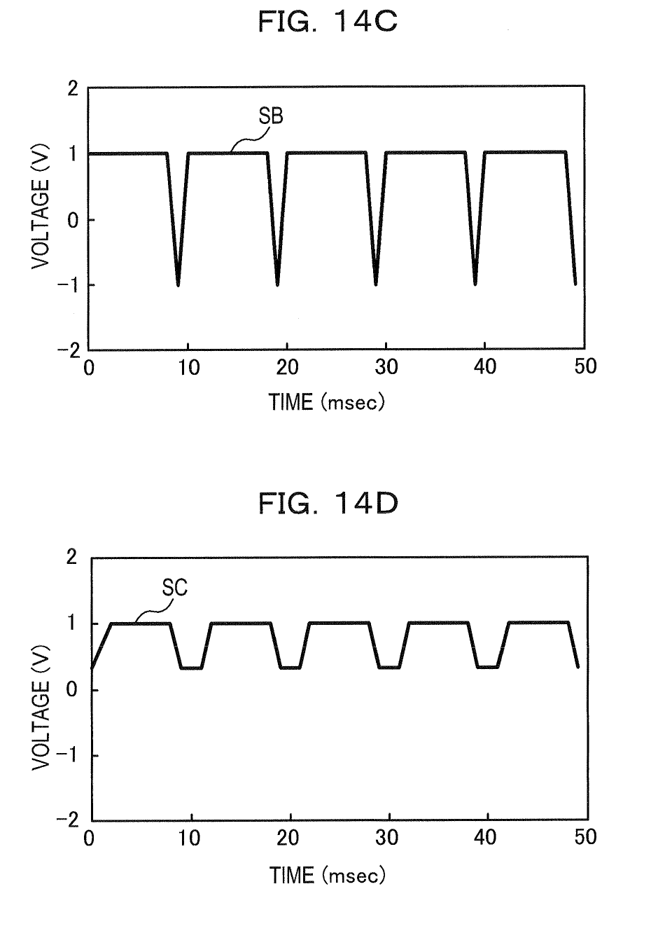

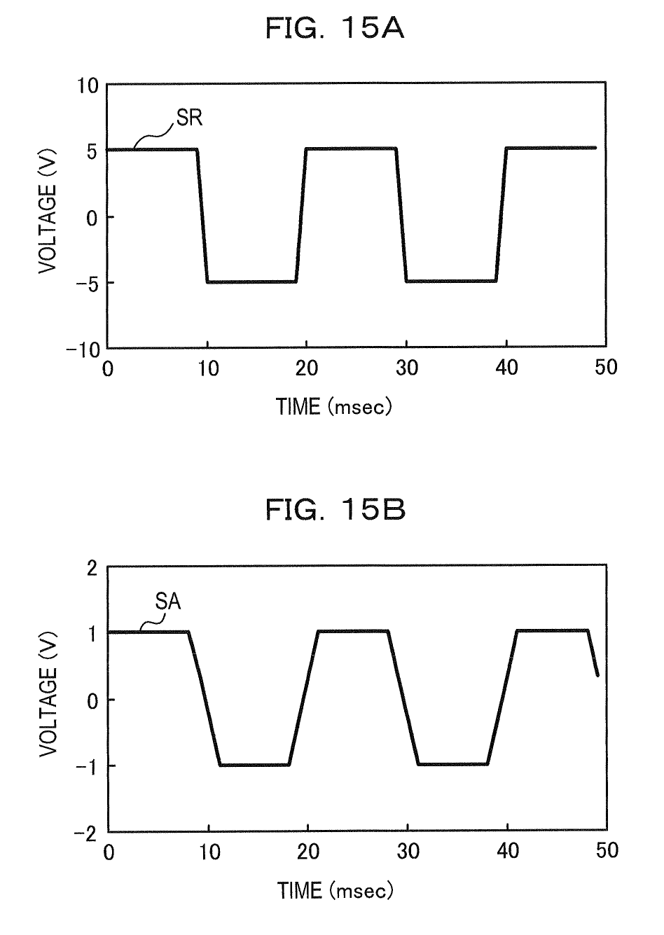

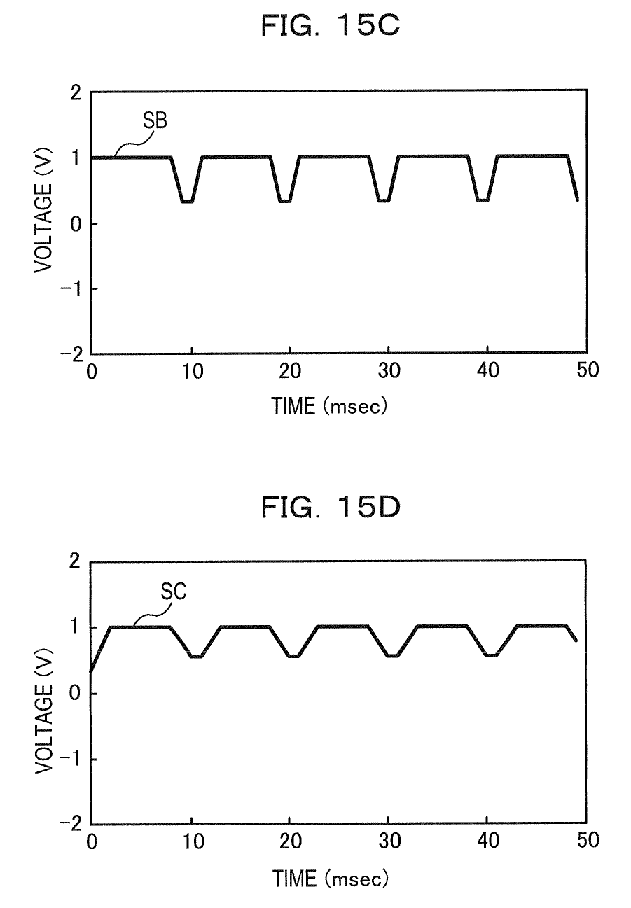

In FIG. 1, as described above, the millimeter wave receiver 111 outputs the DC signal SA (FIG. 12B) detected by the millimeter wave detector 601. The signal SA becomes 1 V (FIG. 12B) or −0.9 V (see FIG. 13B) at the time when control signal SR is at the high level, while the signal SA becomes −1 V at the time when the control signal SR is at the low level. In the period in which the control signal SR is at the high level, the signal SA becomes +1 V at the time when the antenna 101 receives a millimeter wave, and the signal SA becomes −0.9 V at the time when the antenna 101 receives no millimeter wave.

An A/D converter 105 is an analog-to-digital converter and converts the control signal SR outputted by the switch driver 104 from analog to digital form, so as to output the converted signal to an edge detecting section 106. The edge detecting section 106 detects the edge of the digital control signal SR, and controls a switch 112.

The output terminal of the millimeter wave receiver 111 is connected to a terminal T1. The switch 112 connects the terminal T1 to a terminal T2 at the time when the edge portion of the control signal SR is detected, and discards the signal SA corresponding to the edge portion of the control signal SR. Further, the switch 112 connects the terminal T1 to a terminal T3 at the time when the edge portion of the control signal SR is not detected, and leaves only the signal SA corresponding to the portion of the control signal SR other than the edge portion. The terminal T2 is terminated by being connected to the reference potential node via a resistor. Further, the terminal T2 may be short-circuited to the reference potential node. Further, the terminal T2 may be set in an open state (high impedance state). The signal SD illustrated in FIG. 2B is a signal at the terminal T3. In the signal SD, a no-signal state is caused by the high impedance state which is set in correspondence with the edge portion of the control signal SR.

On the basis of the outputs of the A/D converter 105 and the edge detecting section 106, a high level/low level determining section 107 determines whether the control signal SR is at the high level or the low level, and controls a switch 113. The switch 113 connects the terminal T3 to a terminal T4 at the time when the control signal SR is at the high level. The switch 113 connects the terminal T3 to a terminal T5 at the time when the control signal SR is at the low level. The terminal T4 is connected to an input terminal of a multiplier 114, and the terminal T5 is connected to an input terminal of a multiplier 115.

The multiplier 114 multiplies the signal SD inputted via the switch 113 by +1, and outputs the multiplied signal. The multiplier 115 multiplies the signal SD inputted via the switch 113 by −1, and outputs the multiplied signal.

An adder 116 adds the outputs of the multipliers 114 and 115, and outputs the signal SE. When the switch 113 is connected to the multiplier 114, the adder 116 selects the output of the multiplier 114 to output the selected output as the signal SE, while when the switch 113 is connected to the multiplier 115, the adder 116 selects the output of the multiplier 115 to output the selected output as the signal SE. In the signal SE (FIG. 2C), there remains the no-signal state caused by the high impedance state which is set in correspondence with the edge portion of the control signal SR.

An A/D converter 117 converts the signal SE from analogue to digital form, and further shortens the signal SE by eliminating the no-signal portion thereof, so as to output the signal SF (FIG. 2D). The signal SF is a signal obtained in such a manner that the signal SE is shortened by eliminating the portion thereof which corresponds to the high impedance state.

A low pass filter (LPF) 118 passes only the low frequency band signal of the signal SF by removing the high frequency component of the signal SF, and outputs the low frequency band signal to a data measuring section 119. The data measuring section 119 measures the voltage value of the output signal of the low pass filter 118. Note that the low pass filter 118 is not essential, and may be omitted at the time when the noise level is low.

FIGS. 2A to 2D are waveform charts in the case where the antenna 101 receives a millimeter wave. When the antenna 101 receives no millimeter wave, in the waveform charts of FIGS. 13A to 13D, similarly to FIGS. 2A to 2D, a no-signal state is caused in the signal SB by the high impedance state which is set in correspondence with the edge portion of the control signal SR. As a result, the signal SF becomes a signal obtained in such a manner that the signal SE is shortened by eliminating the portion thereof which corresponds to the high impedance state. When the cutoff frequency of the low pass filter 118 is further lowered in this case, the signal SE is further averaged, so that the signal SF becomes close to 1 V.

As described above, the switching operation of the switch 102 is first performed by the control signal SR from the switch driver 104. The control signal SR is converted by the A/D converter 105 from analog to digital form. Then, whether or not the control signal SR is at the edge portion, and whether the control signal SR is at the high level or the low level, are determined by the edge detecting section 106 and the high level/low level determining section 107, respectively. The control signal SR is a signal having a large amplitude, for example, ±5 V, and hence the above described determination is easily performed. At the edge portion which includes the edge of the control signal SR and the timing around the edge, the terminal T1 is connected to the terminal T2 by the switch 112. At the timing other than the edge portion, the switch 112 connects the terminal T1 to the terminal T3. Further, the switch 113 is switched depending on whether the control signal SR is set at the high level or the low level. Thereafter, the data are added by the adder 116 so as to pass through the low pass filter 118, and are then measured by the data measuring section 119.

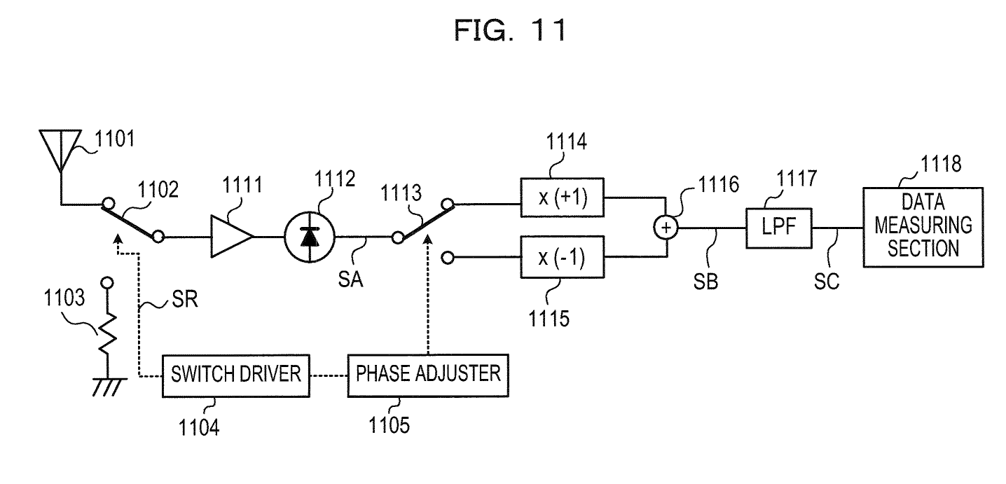

As illustrated in FIGS. 2A to 2D, the signal SA in the edge portion as the rising or falling section of the control signal SR, for example, a period including the switching period of the control signal SR as the edge together with a period of 5% of the switching period before and after the switching period, is discarded by switching the switch 112, and hence the spike voltage is not generated in the signal SE. After converting the signal SE from analog into digital form, the A/D converter 117 shorten the signal SE by eliminating the no-signal portions of the signal SE, and outputs the signal SF. The average voltage of the signal SF is 1 V, and has no error. Of course, actually, a noise is included in the signal SA, and hence an error is generated. In this case, it is prefer to remove the noise by the low pass filter 118. However, there is no noise resulting from the timing difference between the signal SA and the control signal SR. Further, in the present embodiment, it is not necessary to make the phase of the control signal SR completely coincide with the phase of the signal SA. Thereby, the degree of freedom of the present embodiment can be significantly increased as compared with the receiver illustrated in FIG. 11. In the present embodiment, it is not necessary to remove the spike noise in the signal SE, and it is not necessary to lower the cutoff frequency of the low pass filter 118. Therefore, the response speed of the present embodiment is relatively higher.

As described above, when the switch 102 is connected to the antenna 101, the signal SA at the time includes a millimeter wave signal component and a noise component of the millimeter wave receiver (amplifier) 111. When the switch 102 is connected to the resistor 103, the signal SA at the time includes only the noise component of the millimeter wave receiver (amplifier) 111. By switching the switch 113, it is possible to remove the noise component and the time and temperature dependent variations in the gain of the millimeter wave receiver (amplifier) 111.

Note that the multiplier 114 may multiply the signal by +N instead of by +1 and the multiplier 115 may multiply the signal by −N instead of by −1. Here, N is a natural number or a decimal.

The millimeter wave receiver is a circuit which detects a minute millimeter wave signal emitted from an object or a celestial body. The Dicke-type millimeter wave receiver is capable of suppressing the variation in the detection level due to the time and temperature dependent variations in the gain of the receiver. The present embodiment is capable of detecting, with high sensitivity, minute high frequency power in the radio wave astronomy, a passive image sensor, and the like.

### Second Embodiment

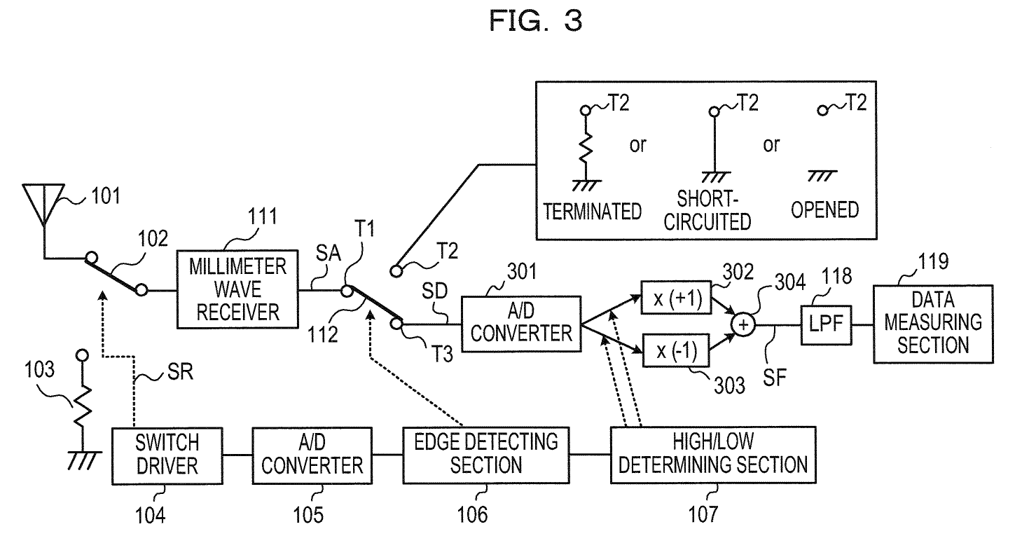

FIG. 3 is a figure illustrating a Dicke-type receiver according to a second embodiment of the present invention. The present embodiment (FIG. 3) is configured such that in the first embodiment (FIG. 1), the switch 113, the multipliers 114 and 115, the adder 116, and the A/D converter 117 are eliminated, and that an A/D converter 301, a multiplication section 302, multiplication section 303, and an adding section 304 are added. In the following, the present embodiment will be described focusing on points different from the first embodiment.

The A/D converter 301 converts the signal SD at the terminal T3 from analog into digital form. On the basis of the output of the A/D converter 105 and the edge detecting section 106, the High level/low level determining section 107 determines whether the control signal SR is at the high level or the low level. When it is determined by the high level/low level determining section 107 that the control signal SR is at the high level, the multiplication section 302 multiplies the output of the A/D converter 301 by +1 at the timing, and outputs the multiplied signal. Further, when it is determined by the high level/low level determining section 107 that the control signal SR is at the low level, the multiplication section 303 multiplies the output of the A/D converter 301 by −1 at the timing, and outputs the multiplied signal.

The adding section 304 adds the outputs of the multiplication section 302 and the multiplication section 303, and shortens the added signal by eliminating the no-signal portions of the added signal, so as to output the signal SF. Specifically, when the control signal SR is at the high level, the adding section 304 selects the output of the multiplication section 302, and outputs the selected signal as the signal SF. When the control signal SR is at the low level, the adding section 304 selects the output of the multiplication section 303, and outputs the selected signal as the signal SF. However, the adding section 304 outputs the signal SF by eliminating the no-signal portion thereof which corresponds to the edge portion of the control signal SR. Thereafter, the processing of the low pass filter 118 and the data measuring section 119 is performed similarly to the first embodiment.

Note that the multiplication section 302 may multiply the signal by +N instead of by +1 and the multiplication section 303 may multiply the signal by −N instead of by −1. Here, N is a natural number or a decimal.

The present embodiment is configured such that the A/D converter 301 is connected immediately after the switch 112, and that the switching is performed by software instead of by the switch 113 as hardware, to thereby realize the same function as that of the first embodiment.

### Third Embodiment

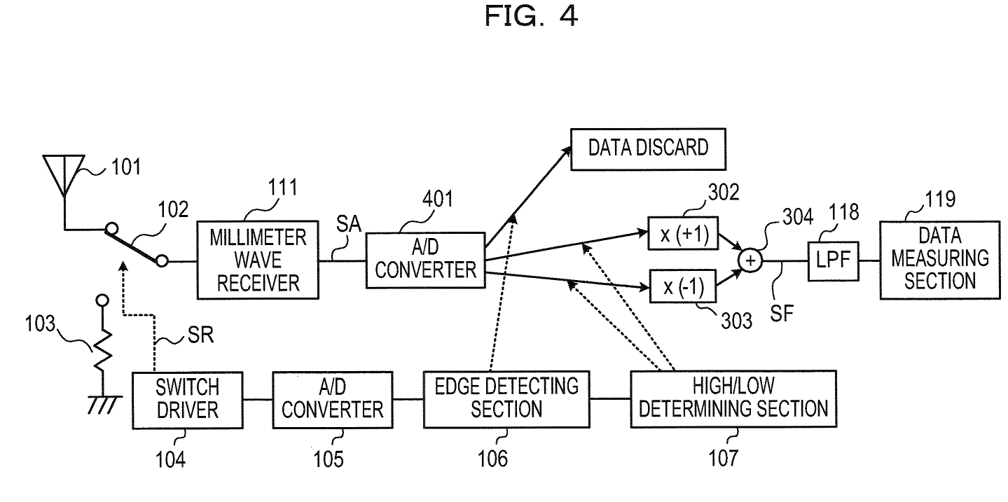

FIG. 4 is a figure illustrating a Dicke-type receiver according to a third embodiment of the present invention. The present embodiment (FIG. 4) is configured such that in the second embodiment (FIG. 3), the switch 112, and the A/D converter 301 are eliminated, and that an A/D converter 401 is added. In the following, the present embodiment will be described focusing on points different from the second embodiment.

The A/D converter 401 converts the signal SA from analog into digital form. When detecting the edge portion of the control signal SR, the edge detecting section 106 discards the output of the A/D converter 401 at the timing. When the edge portion of the control signal SR is not detected, the A/D converter 401 outputs the output thereof at the timing to the multiplication section 302 or the multiplication section 303. When it is determined by the high level/low level determining section 107 that the control signal SR is at the high level, the multiplication section 302 multiplies the output of the A/D converter 401 by +1 at the timing, and outputs the multiplied signal. When it is determined by the high level/low level determining section 107 that the control signal SR is at the low level, the multiplication section 303 multiplies the output of the A/D converter 401 by −1 at the timing, and outputs the multiplied signal.

The adding section 304 adds the output signals of the multiplication section 302 and the multiplication section 303, and shortens the added signal by eliminating the no-signal portions of the added signal, so as to output the signal SF. Thereafter, the processing of the low pass filter 118 and the data measuring section 119 is performed similarly to the first embodiment.

In the present embodiment, the A/D converter 401 converts the output signal SA of the millimeter wave receiver 111 from analog into digital form. As the A/D converter 401, a converter having a high response speed and high performance is preferred. However, in the present embodiment, the number of switches is small, so that the cost is reduced. The function of the present embodiment is the same as that of the first and second embodiments.

### Fourth Embodiment

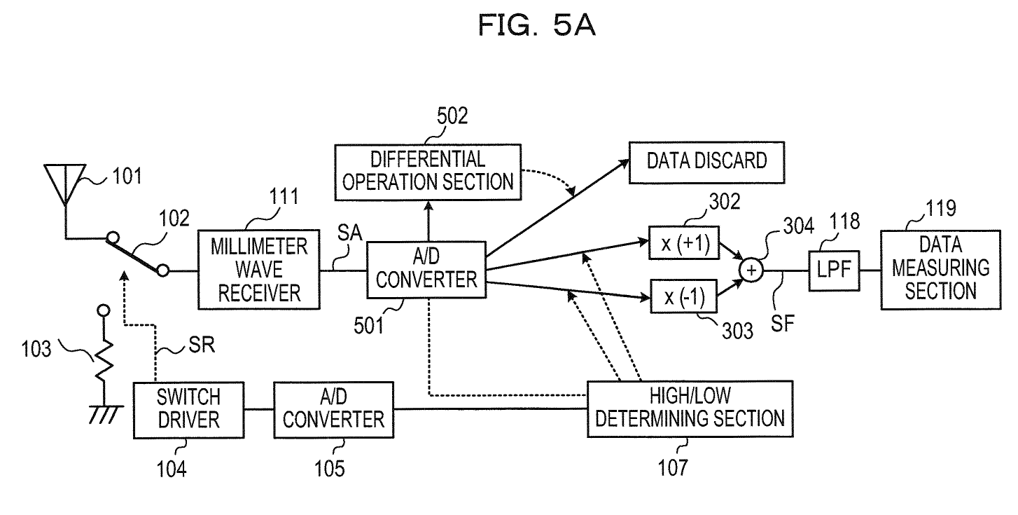

FIG. 5A is a figure illustrating a Dicke-type receiver according to a fourth embodiment of the present invention. FIG. 5B illustrates waveform charts for explaining an operation of the apparatus illustrated in FIG. 5A. The present embodiment (FIG. 5A) is configured such that in the third embodiment (FIG. 4), the edge detecting section 106 and the A/D converter 401 are eliminated, and that an A/D converter 501 and a differential operation section 502 are added. In the following, the present embodiment will be described focusing on points different from the third embodiment.

The A/D converter 501 converts the output signal SA of the millimeter wave receiver 111 from analog into digital form. FIG. 5B illustrates an example of the signal SA. The signal SA may include a noise, and has rising and falling edges with an inclination. The differential operation section 502 differentiates the output signal of the A/D converter 501, and generates a differential signal illustrated in FIG. 5B. The differential signal becomes a signal of a positive value at the rising edge of the signal SA, and becomes a signal of a negative value at the falling edge of the signal SA. The differential signal becomes approximately zero at the high level and low level portions of the signal SA. The differential operation section 502 is able to determine that the period TB, in which the absolute value of the differential signal is larger than a threshold value, is the edge portion of the signal SA, and that the period TA, in which the absolute value of the differential signal is smaller than the threshold value, is not the edge portion of the signal SA. The differential operation section 502 is able to detect the edge portion of the signal SA similarly to the edge detecting section 106 illustrated in FIG. 4.

When detecting the edge portion of the signal SA, the differential operation section 502 discards the output of the A/D converter 501 at the timing. When detecting no edge portion of the signal SA, the differential operation section 502 outputs the output of the A/D converter 501 at the timing to the multiplication section 302 or the multiplication section 303. The High level/low level determining section 107 is able to determine, on the basis of the output signal of the A/D converter 105, whether the control signal SR is at the high level or the low level. When it is determined by the high level/low level determining section 107 that the control signal SR is at the high level, the multiplication section 302 multiplies the output signal of the A/D converter 501 by +1 at the timing, and outputs the multiplied signal. When it is determined by the high level/low level determining section 107 that the control signal SR is at the low level, the multiplication section 303 multiplies the output signal of the A/D converter 501 by −1 at the timing, and outputs the multiplied signal.

The adding section 304 adds the output signals of the multiplication section 302 and the multiplication section 303, and shortens the added signal by eliminating the no-signal portions of the added signal, so as to output the signal SF. Thereafter, the processing of the low pass filter 118 and the data measuring section 119 is performed similarly to the first embodiment.

Note that there is described, as an example, a case where the high level/low level determining section 107 determines whether the control signal SR is at the high level or the low level, but the high level/low level determining section 107 may be configured so as to determine, on the basis of the output signal of the A/D converter 501, whether the control signal SR is at the high level or the low level. For example, in the case where there is a reception signal as illustrated in FIG. 12B, it is possible to determine that when the output signal SA of the millimeter wave receiver 111 is 1 V, the control signal SR is at the high level, and that when the output signal SA of the millimeter wave receiver 111 is −1 V, the control signal SR is at the low level. Further, when there is no reception signal as illustrated in FIG. 13B, it is possible to determine that when the output signal SA of the millimeter wave receiver 111 is −0.9 V, the control signal SR is at the high level, and that when the output signal SA of the millimeter wave receiver 111 is −1 V, the control signal SR is at the low level. In this case, the A/D converter 105 is not used. When it is determined by the high level/low level determining section 107 that the control signal SR is at the high level, the multiplication section 302 multiplies the output signal of the A/D converter 501 by +1 at the timing, and outputs the multiplied signal. Further, when it is determined by the high level/low level determining section 107 that the control signal SR is at the low level, the multiplication section 303 multiplies the output signal of the A/D converter 501 by −1 at the timing, and outputs the multiplied signal. The following description is the same as described above.

The first embodiment to the fourth embodiment are configured such that the data at the edge portion of the signal SA are not used but the data at the portion of the signal SA other than the edge portion are used. The present embodiment is configured such that the edge portion of the signal SA is detected in order to reduce as much as possible the time period in which the data are not used. It is possible to improve the sensitivity of the receiver by reducing the section in which the data are discarded. The differential operation section 502 differentiates the signal SA. The differential signal changes at the edge portion of the signal SA. However, the differential signal becomes zero in the period after the rise or fall of the signal SA. The present embodiment uses only the data in the section in which the differential signal is zero. Thereby, it is possible to use only the data at the portion of the signal SA other than the edge portion.

### Fifth Embodiment

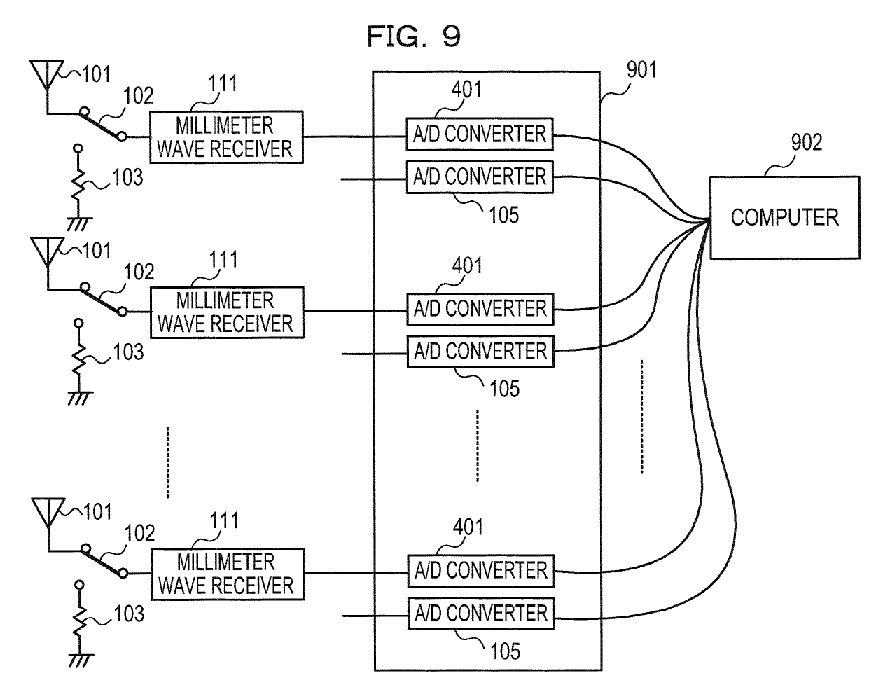

FIG. 9 is a figure illustrating a configuration example of a signal processing system according to a fifth embodiment of the present invention. In the third embodiment (FIG. 4), the digital signal processing performed in the subsequent stage of the A/D converters 105 and 401 may be performed by hardware processing or software processing. In the present embodiment (FIG. 9) the subsequent stage of the A/D converters 105 and 401, which stage includes the edge detecting section 106, the high level/low level determining section 107, the multiplication section 302, the multiplication section 303, the adding section 304, the low pass filter 118, and the data measuring section 119 of the third embodiment (FIG. 4), is realized by a computer 902.

The signal processing system of the present embodiment is, for example, a passive image sensor, and includes a plurality of sets of the circuits illustrated in FIG. 4. In the signal processing system, there are arranged a plurality of sets, each of which includes the antenna 101, the switch 102, the resistor 103, the millimeter wave receiver 111, the A/D converter 401, the switch driver 104, and the data converter 105 in FIG. 4. The plurality of antennas 101 are two-dimensionally arranged. The plurality of two-dimensionally arranged antennas 101 correspond to respective pixels of the image sensor. For example, the antenna 101 receives a minute millimeter wave signal emitted from an object or a celestial body. This enables the signal processing system to generate a two-dimensional image similarly to a digital camera image.

The plurality of A/D converters 401 and the plurality of A/D converters 105 are mounted on an A/D (analog/digital) conversion board 901. The computer 902, to which the output terminals of the A/D converters 401 and 105 in the A/D conversion board 901 are connected, performs the processing of the plurality sets, each of which includes the edge detecting section 106, the high level/low level determining section 107, the multiplication section 302, the multiplication section 303, the adding section 304, the low pass filter 118, and the data measuring section 119 in FIG. 4.

Note that the plurality of sets of the switch driver 104 and the data converter 105 are not provided but one set of the switch driver 104 and the data converter 105 may be provided for common use. In this case, the A/D conversion board 901 includes the plurality of A/D converters 401 and the one A/D converter 105. The computer 902 is connected to the output terminals of the plurality of A/D converters 401 and the output terminal of the one A/D converter 105.

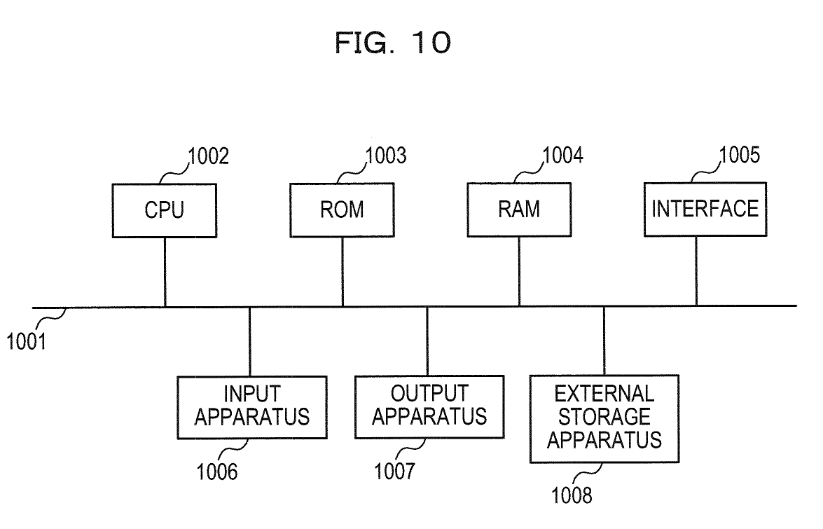

FIG. 10 is a block diagram illustrating an example of a hardware configuration of the computer 902. The computer 902 is, for example, a personal computer. A central processing unit (CPU) 1002, a Read Only Memory (ROM) 1003, a Random Access Memory (RAM) 1004, an interface 1005, an input apparatus 1006, an output apparatus 1007, and an external storage apparatus 1008 are connected to a bus 1001.

The CPU 1002 is configured to perform a processing or arithmetic operation of data and to control the various components connected via the bus 1001. In one embodiment, a control procedure (computer program) of the CPU 1002 is stored beforehand in the ROM 1003, and is started at the time when the CPU 1002 executes the computer program. The computer program is stored in the external storage apparatus 1008, and the computer program is copied in the RAM 1004, so as to be executed. The RAM 1004 is used as a work memory for input/output and transmission/reception of data, and is used as a temporary storage for control of the respective components. The external storage apparatus 1008 is, for example, a hard disk storage apparatus, a CD-ROM, and the like. Even when the electric power is turned off, the contents stored in the external storage apparatus 1008 may not be lost. The CPU 1002 executes the computer program stored in the RAM 1004 to thereby execute the processing of the edge detecting section 106, the high level/low level determining section 107, the multiplication section 302, the multiplication section 303, the adding section 304, the low pass filter 118, and the data measuring section 119 which are illustrated in FIG. 4.

The interface 1005 is an interface which is connected to the A/D converter 401 and the A/D converter 105 in FIG. 9 and which receives the output signals of A/D converter 401 and the A/D converter 105. The input apparatus 1006 is, for example, a keyboard, a mouse, and the like, and enables various specifying operations, input operations, and the like. The output apparatus 1007 is a display, a printer, and the like.

The present embodiment can be realized in such a manner that the computer 902 executes the program. Further, supplying the program to the computer, for example, a computer readable recording medium, such as a CD-ROM, in which the program is recorded, or a transmission medium, such as the Internet, which transmits the program, can also be applied as an embodiment of the present invention. Further, a computer program product, such as a computer readable recording medium in which the above described program is recorded, can also be applied as an embodiment of the present invention. The program, the recording medium, the transmission medium, and the computer program product, as described above, are included in the scope of the present invention. As the recording medium, it is possible to use, for example, a flexible disk, a hard disk, an optical disk, a magneto-optical disk, a CD-ROM, a magnetic tape, a nonvolatile memory card, a ROM, and the like.

In the above, there is described a case where the third embodiment (FIG. 4) is realized by using the computer 902. However, similarly, the first, second and fourth embodiments can also be realized by using the computer 902. In the first, second and fourth embodiments, the digital signal processing in the subsequent stage of the A/D converters 105, 117, 301, 401 and 501 may be performed by the hardware processing or software processing. In the case of the software processing, the digital signal processing can be realized by the computer 902.

### Sixth Embodiment

FIG. 8 is a figure illustrating a receiver and a signal processing system according to a sixth embodiment of the present invention. In the present embodiment, a chopper 801 is provided instead of the switch 102 and the resistor 103 which are used in the receiver according to the first to fourth embodiments and in the signal processing system according to the fifth embodiment. The chopper 801 is arranged in front of the antenna 101. The millimeter wave receiver 111 is directly connected to the antenna 101. The switch 102 in the first to fifth embodiments is a high frequency component which causes a high frequency loss. A radio wave absorber is adhered to the chopper 801. A driver 104 corresponds to the switch driver 104 in the first to fifth embodiments, and outputs the control signal SR. The chopper 801 is rotated according to the control signal SR. The radio wave absorber adhered to the chopper 801 is located in front of the antenna 101 during a half period of one cycle, while the radio wave absorber adhered to the chopper 801 is not located in front of the antenna 101 during the residual half period of the one cycle. When the radio wave absorber adhered to the chopper 801 is located in front of the antenna 101, the radio wave absorber adhered to the chopper 801 absorbs the radio wave (millimeter wave). Thereby, the radio wave is not received by the antenna 101, so that there results the same state as the state where the switch 102 is connected to the resistor 103 in the first to fifth embodiments. Further, when the radio wave absorber adhered to the chopper 801 is not located in front of the antenna 101, the antenna 101 is able to receive the radio wave, so that there results the same state as the state where the switch 102 is connected to the millimeter wave receiver 111 in the first to fifth embodiments. In this way, the chopper 801 performs the same function as that of the switch 102. The chopper 801 has a disadvantage of having a comparatively large size, but has an advantage of having no high frequency loss.

Note that in the first to sixth embodiments, there is described, for example, a case where a millimeter wave is received, but a radio wave other than the millimeter wave may be received.

As described above, the receiver of the first to third embodiments and of the fifth and sixth embodiments includes the antenna 101 for receiving a radio wave, and the detector 601 for detecting the signal received via the antenna 101 and for outputting the output signal.

A state control section such as the switch 102 or the chopper 801 performs, according to the control signal SR, control between the first state where the antenna 101 is able to receive a radio wave and where the detector 601 is able to receive the signal received by the antenna 101, and the second state where the first state is not effected. In FIG. 1, FIG. 3 and FIG. 4, the state control section is the first switch 102 which connects the input terminal of the detector 601 to the antenna 101 or the resistor 103 according to the control signal SR. In FIG. 8, the state control section is the chopper 801 which is arranged in front of the antenna 101, which has the radio wave absorber, and which is rotated according to the control signal SR.

An edge portion processing section, which includes the edge detecting section 106, is configured, when detecting the edge portion of the control signal SR, to discard the output signal SA of the detector 601, which output signal corresponds to the edge portion of the control signal SR. Further, the edge detecting section 106 is configured, when not detecting the edge portion of the control signal SR, to leave the output signal SA of the detector 601, which output signal corresponds to the portion of the control signal SR other than the edge portion.

A high level/low level processing section, which includes the high level/low level determining section 107, is configured, when the control signal SR is at the high level, to multiply the signal, which corresponds to the high level of the control signal SR and which is left by the edge portion processing section, by a first coefficient. Further, the high/low level determining section 107 is configured, when the control signal SR is at the low level, to multiply the signal, which corresponds to the low level of the control signal SR and which is left by the edge portion processing section, by a second coefficient having a positive or negative sign opposite to the first coefficient.

The adding section 116 or 304 is configured, when the control signal SR is at the high level, to select and output the signal multiplied by the first coefficient. Further, the adding section 116 or 304 is configured, when the control signal SR is at the low level, to select and output the signal multiplied by the second coefficient.

In FIG. 6B, the amplifier 602 is connected between the antenna 101 and the detector 601. Further, in FIG. 6C, the mixer 604 is connected between the antenna 101 and the detector 601, and mixes the received signal with the local signal LO.

Further, in FIG. 4, the analog-to-digital converter 401 is connected between the detector 601 and the edge portion processing section, and converts a signal from analog into digital form.

Further, in FIGS. 1 and 3, the edge portion processing section includes the second switch 112 that is configured, when the edge portion processing section detects the edge portion of the control signal SR, to connect the first terminal T2 of the second switch 112 with the output signal SA of the detector 601, which output signal corresponds to the edge portion of the control signal SR. Further, the second switch 112 is configured, when the edge portion processing section does not detect the edge portion of the control signal SR, to connect the second terminal T3 of the second switch 112 with the output signal SA of the detector 601, which output signal corresponds to the portion of the control signal SR other than the edge portion. The high level/low level processing section is connected to the second terminal T3 of the second switch 112. The first terminal T2 of the second switch 112 is terminated, short circuited, or opened.

Further, in FIG. 3, the analog-to-digital converter 301 is connected between the second terminal T3 of the second switch 112 and the high level/low level processing section, and converts a signal from analog into digital form.

Further, in FIG. 1, the analog-to-digital converter 117 converts the output signal SE of the adding section 116 from analog into digital form, and shortens the output signal SE by eliminating the no-signal portions thereof.

Further, in FIG. 1, the high level/low level processing section includes the first multiplication section (multiplier) 114 configured to multiply the first coefficient, the second multiplication section (multiplier) 115 configured to multiply the second coefficient, and the third switch 113 that is configured, when the control signal SR is at the high level, to connect the second terminal T3 of the second switch 112 to the input terminal of the first multiplication section 114. Further, the third switch 113 is configured, when the control signal SR is at the low level, to connect the second terminal T3 of the second switch 112 to the input terminal of the second multiplication section 115.

Further, in FIGS. 1, 3 and 4, the low pass filter 118 is connected to the subsequent stage of the adding section 116 or the adding section 304, and removes the high frequency component.

Further, the fifth embodiment is the signal processing system which receives a signal from the receiver including: the antenna 101 for receiving a radio wave; the detector 601 for detecting the signal received via the antenna 101 and for outputting an output signal; and a state control section configured, according to the control signal SR, to perform control between the first state where the antenna 101 is able to receive the radio wave and where the detector 601 is able to receive the signal received by the antenna 101, and the second state where the first state is not effected.

In the signal processing system of the fifth embodiment, the edge portion processing section is configured, when detecting the edge portion of the control signal SR, to discard the output signal SA of the detector 601, which output signal corresponds to the edge portion of the control signal SR. Further, the edge detecting portion processing section is configured, when not detecting the edge portion of the control signal SR, to leave the output signal of the detector 601, which output signal corresponds to the portion of the control signal SR other than the edge portion. The high level/low level processing section is configured, when the control signal SR is at the high level, to multiply the signal, which corresponds to the high level of the control signal SR and which is left by the edge portion processing section, by the first coefficient. Further, the high level/low level processing section is configured, when the control signal SR is at the low level, to multiply the signal, which corresponds to the low level of the control signal SR and which is left by the edge portion processing section, by the second coefficient having a positive or negative sign opposite to the first coefficient. The adding section 116 or 304 is configured to select and output the signal multiplied by the first coefficient at the time when the control signal SR is at the high level, and the adding section 116 or 3094 is configured to select and output the signal multiplied by the second coefficient at the time when the control signal SR is at the low level.

Further, the signal processing system (receiver) illustrated in FIG. 5 receives a signal from the receiver including: the antenna 101 for receiving a radio wave; the detector 601 for detecting the signal received via the antenna 101 and for outputting an output signal; and a state control section configured, according to the control signal SR, to perform control between the first state where the antenna 101 is able to receive the radio wave and where the detector 601 is able to receive the signal received by the antenna 101, and the second state where the first state is not effected.

In the signal processing system (receiver) illustrated in FIG. 5, the edge portion processing section is configured, when detecting the edge portion of the output signal SA of the detector 601, to discard the output signal SA of the detector 601, and the edge portion processing section is configured, when not detecting the edge portion of the output signal SA of the detector 601, to leave the output signal SA of the detector 601. The high level/low level processing section is configured, when the control signal SR is at the high level, to multiply the signal, which corresponds to the high level of the control signal SR and which is left by the edge portion processing section, by the first coefficient, and high level/low level processing section is configured, when the control signal SR is at the low level, to multiply the signal, which corresponds to the low level of the control signal SR and which is left by the edge portion processing section, by the second coefficient having a positive or negative sign opposite to the first coefficient. The adding section 304 is configured, when the control signal SR is at the high level, to select and output the signal multiplied by the first coefficient, and adding section 304 is configured, when the control signal SR is at the low level, to select and output the signal multiplied by the second coefficient. The high level/low level processing section is configured, on the basis of the control signal SR, to detect whether the control signal SR is at the high level or the low level. Further, the high level/low level processing section may also be configured, on the basis of the output signal SA of the detector 601, to detect whether the control signal SR is at the high level or the low level.

As described above, the generation of the spike voltage can be prevented by discarding the signal corresponding to the edge portion. Further, since it does not remove the spike voltage by using the low pass filter, it is possible to prevent the response speed from being lowered.

All examples and conditional language recited herein are intended for pedagogical purposes to aid the reader in understanding the invention and the concepts contributed by the inventor to furthering the art, and are to be construed as being without limitation to such specifically recited examples and conditions, nor does the organization of such examples in the specification relate to a showing of the superiority and inferiority of the invention. Although the embodiments of the present inventions have been described in detail, it should be understood that the various changes, substitutions, and alterations could be made hereto without departing from the spirit and scope of the invention.

What is claimed is:

1. A receiver comprising:
a detector configured to detect a signal received via an antenna and output an output signal;
a state control section configured to control the signal to be received by the detector according to a level of a control signal;
an edge portion processing section configured to discard the output signal of the detector while detecting an edge portion of the control signal, and leave the output signal of the detector while not detecting the edge portion of the control signal;
a high level/low level processing section configured to multiply the output signal which is left by the edge portion processing section by a first coefficient while the level of the control signal is high, and multiply the output signal which is left by the edge portion processing section by a second coefficient while the level of the control signal is low; and
an adding section configured to output a first multiplied signal multiplied by the first coefficient while the level of the control signal is high, and output a second multiplied signal multiplied by the second coefficient while the level of the control signal is low.

2. The receiver according to claim 1,
wherein the state control section is a first switch connecting the input terminal of the detector to the antenna or a resistor.

3. The receiver according to claim 1,
wherein the state control section is a chopper which is arranged in front of the antenna such that the chopper limits the signal available to be received by the antenna.

4. The receiver according to claim 1, further comprising:
an amplifier connected between the antenna and the detector.

5. The receiver according to claim 1, further comprising:
a mixer connected between the antenna and the detector.

6. The receiver according to claim 1, further comprising:
an analog-to-digital converter connected between the detector and the edge portion processing section.

7. The receiver according to claim 1,
wherein the edge portion processing section includes a second switch connecting the detector to a first terminal while the edge portion processing section detects the edge portion of the control signal, and connecting the detector to a second terminal while the edge portion processing section does not detect the edge portion of the control signal, and
wherein the high level/low level processing section is connected to the second terminal of the second switch.

8. The receiver according to claim 7,
wherein the first terminal of the second switch is terminated.

9. The receiver according to claim 7,
wherein the first terminal of the second switch is short-circuited.

10. The receiver according to claim 7,
wherein the first terminal of the second switch is opened.

11. The receiver according to claim 7, further comprising:
an analog-to-digital converter connected between the second terminal of the second switch and the high level/low level processing section.

12. The receiver according to claim 7, further comprising:
an analog-to-digital converter configured to convert a output signal of the adding section from analog into digital form, and shorten the output signal of the adding section by eliminating a no-signal portion of the output signal of the adding section.

13. The receiver according to claim 7,
wherein the high level/low level processing section comprises:
a first multiplication section configured to multiply the first coefficient;
a second multiplication section configured to multiply the second coefficient; and
a third switch configured to connect the second terminal of the second switch to the first multiplication section while the level of the control signal is high, and connect the second terminal of the second switch to the second multiplication section while the level of the control signal is low.

14. The receiver according to claim 1, further comprising:
a low pass filter connected to the subsequent stage of the adding section.

15. A signal processing system comprising:
a receiving section configured to receive a output signal from a detector detecting a signal received via an antenna and the output signal is controlled by a control section according to a level of a control signal;
an edge portion processing section configured to discard the output signal of the detector while detecting an edge portion of the control signal, and leave the output signal of the detector while not detecting the edge portion of the control signal;
a high level/low level processing section configured to multiply the output signal which is left by the edge portion processing section by a first coefficient while the level of the control signal is high, and multiply the output signal which is left by the edge portion processing section by a second coefficient while the level of the control signal is low; and
an adding section configured to output a first multiplied signal multiplied by the first coefficient while the level of the control signal is high, and output a second multiplied signal multiplied by the second coefficient while the level of the control signal is low.

16. The signal processing system according to claim 15,
wherein the edge portion processing section includes a second switch connecting the detector to a first terminal while the edge portion processing section detects the edge portion of the control signal, and connecting the detector to a second terminal while the edge portion processing section does not detect the edge portion of the control signal, and
wherein the high level/low level processing section is connected to the second terminal of the second switch.

17. The signal processing system according to claim 16,
wherein the high level/low level processing section comprises:
a first multiplication section configured to multiply the first coefficient;
a second multiplication section configured to multiply the second coefficient; and
a third switch configured to connect the second terminal of the second switch to the first multiplication section while the level of the control signal is high, and connect the second terminal of the second switch to the second multiplication section while the level of the control signal is low.

18. The signal processing system according to claim 18,
wherein the high level/low level processing section detects whether the level of the control signal is high or low on the basis of the control signal.

19. The signal processing system according to claim 18,
wherein the high level/low level processing section, detects whether the level of the control signal is high or low on the basis of the output signal of the detector.
